(19) United States
(12) Patent Application Publication
(10) Pub. No.: US 2014/0008275 A1
(43) Pub. Date: Jan. 9, 2014

(54) WATER TREATMENT APPARATUS INTEGRATED WITH WATER METER USING MAGNET

(71) Applicant: Sang Ku LEE, Daejeon (KR)

(72) Inventor: Sang Ku LEE, Daejeon (KR)

(21) Appl. No.: 13/686,937

(22) Filed: Nov. 28, 2012

(30) Foreign Application Priority Data
Jul. 6, 2012 (KR) 2012-0074043

(51) Int. Cl. C02F 1/48

(52) U.S. Cl. CPC C02F 1/48
USPC 210/85

(57) ABSTRACT

A water meter integrated water treatment apparatus. At least one coil spring is disposed inside at least one of water pipes which are connected to both sections of a water meter. The coil spring is in close contact with an inner diameter surface of the water pipe. At least two magnets are disposed inside and in close contact with an inner diameter surface of the coil spring. An interval is formed between the magnets in a longitudinal direction of the water pipe. The inner diameter surface of the water pipe, the coil spring and the magnets are in close and sealing contact with each other, thereby forming a water passage through which water flows. Tap water that is to be introduced into a building through the water meter can be magnetized (ionized).

### CROSS-REFERENCE TO RELATED APPLICATIONS AND CLAIM OF PRIORITY

This application claims priority from Korean Patent Application No. 2012-0074043, filed on Jul. 6, 2012, in the Korean Intellectual Property Office, the disclosure of which is incorporated herein by reference.

### BACKGROUND

1. Field of the Invention

The present invention relates, in general, to a water meter integrated water treatment apparatus.

2. Description of the Related Art

Water ionizing devices which produce ionized water by ionizing tap water using the magnetic features of permanent magnets are currently being distributed and used. Ionized water forms a pentagonal or hexagonal ring structure in which water molecules are connected together. When flowing tap water is influenced by a magnetic field, water molecules decreased in size and become minute, thereby improving penetrating ability, solubility and cleaning performance.

In general, an atom of a substance consists of a nucleus having a positive charge and electrons having a negative charge. Electrons vibrate and orbit around the nucleus, thereby generating magnetic force. When the magnetic force is influenced by a permanent magnet or the like, repulsion occurs in the case of the same polarity or attraction occurs in the case of different polarities. Such an interaction between magnetic forces may cause an electron having a negative charge to be separated from the nucleus. This is because the possibility of the electron being separated from the nucleus is increased in the state in which the level of ionization energy is raised by an external stimulus.

Ionization devices which ionize water, such as tap water, using permanent magnets based on that principle are devised and distributed in a variety of types. Korean Utility Model Registration No. 20-0381587 (Apr. 4, 2005) proposed a configuration which ionizes water that flows inside a pipe with magnets being disposed outside the pipe. This is characterized in that one or two water ionizing devices are provided to ionize flowing water. However, this has the problem of having too great a distance between the flowing water and the magnets, which degrades magnetization (ionization). Considering that magnetic force is applied from outside the pipe, the flowing water is not directly influenced by the magnetic force, and thus efficiency may decrease, which is problematic.

Korean Utility Model Registration No. 20-0437393 (Nov. 22, 2007) is characterized in that a plurality of magnets are disposed inside a pipe and spacers are interposed between the magnets, such that water can be magnetized (ionized) while being directly exposed to the magnets. However, this has a problem in that flowing water comes into contact with only the surfaces of the magnets, which degrades the efficiency of the magnetization (ionization) of water. Specifically, owing to the structure in which intervals between the magnets are closed using the spacers, water does not flow between the magnets but passes along the outer surface of the magnets. Consequently, water is not directly influenced by the magnets, and thus the influence of magnetic force is limited.

Korean Patent No. 10-0842787 (Jun. 25, 2008) is characterized in that a plurality of permanent magnet rods is disposed inside a filter housing and springs which produce a swirl are respectively disposed on the permanent magnet rods, such that flowing water is magnetized (ionized) under the influence of the magnets while being swirled by the springs. However, this has a problem in that the springs are disposed along the direction in which water flows but do not increase the length of stay of the flowing water in the housing. That is, since the speed of flowing water is not changed, the length of time that the water is influenced by magnetic force is not increased even if a swirl is produced.

In addition, in the related art, a magnetization (ionization) device is separately prepared, and then the process of assembling the device at a predetermined position of a pipe is performed. When the device is replaced or removed, the surrounding structure including the pipe must be replaced or removed together. This also causes the problem of increases in cost, labor and the like.

### SUMMARY

Accordingly, one or more embodiments of the present invention has been made keeping in mind the above problems occurring in the related art, and one or more embodiments of the present invention is intended to propose a water treatment apparatus which is integrated with a water meter. In this water meter integrated water treatment apparatus, magnets are disposed inside at least one water pipe connected to the water meter such that the magnets are spaced apart from each other and magnetic poles of the same polarity oppose each other, and a coil spring is disposed so as to be in close contact with the outer surfaces of the magnets and the inner surface of the water pipe. Consequently, water that flows through the water meter passes through the space which is defined by the inner surface of the water pipe, the surfaces of the magnets and the coil spring, thereby increasing the length of stay of the water inside the water pipe. Since water passes through the intervals between the magnets, the length of time that the water is exposed to magnetic force is also increased.

According to one aspect of the present invention, there is provided a water meter integrated water treatment apparatus which includes: at least one coil spring disposed inside at least one of water pipes which are connected to both sections of a water meter, the coil spring being in close contact with an inner diameter surface of the water pipe; and at least two magnets disposed inside and in close contact with an inner diameter surface of the coil spring. An interval is formed between the magnets in a longitudinal direction of the water pipe, and the inner diameter surface of the water pipe, the coil spring and the magnets are in close and sealing contact with each other, thereby forming a water passage through which water flows.

In an exemplary embodiment of the water meter integrated water treatment apparatus, the water that flows through the water pipe may swirl and pass through the water passage, and passes through the interval formed between the magnets.

In an exemplary embodiment of the water meter integrated water treatment apparatus, the at least two magnets may be arranged such that magnetic poles of the same polarity oppose each other, thereby generating repulsive force.

In an exemplary embodiment of the water meter integrated water treatment apparatus, the magnets may be fixed to the coil spring such that the interval is maintained to be uniform.

According to embodiments of the invention, since the water treatment apparatus is integrated with the water meter, replacement or repairing thereof is easy and economical because it is not required to replace other surrounding structures such as the pipe.

In addition, according to embodiments of the invention, water passes through the space which is defined by the inner surface of the water pipe, the surfaces of the magnets and the coil spring, thereby increasing the time of its stay. Furthermore, water is influenced by repulsive force while passing through the intervals between the magnets. Since water is continuously influenced by the magnetic force in this way, the effect of magnetization (ionization) is increased.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a perspective view showing water pipes which are connected to a typical type of water meter;

FIG. 2 is a perspective view depicting that a water treatment apparatus can be implementable inside a water pipe connected to a water meter according to an embodiment of the present invention;

FIG. 3 is a partially cut away perspective view showing a water meter integrated water treatment apparatus according to an embodiment of the present invention;

FIG. 4 is a perspective view showing the shape of some parts of the water meter integrated water treatment apparatus according to an embodiment of the present invention, including a plurality of magnets which are spaced apart from each other and a coil spring which is wound on the magnets;

FIG. 5 is a perspective cross-sectional view showing the water pipe, coil spring and the magnets of the water meter integrated water treatment apparatus according to an embodiment of the present invention; and

FIG. 6 is a front cross-sectional view showing the water pipe, coil spring and the magnets of the water meter integrated water treatment apparatus according to an embodiment of the present invention.

### DETAILED DESCRIPTION

Reference will now be made in greater detail to an exemplary embodiment of the present invention, an example of which is illustrated in the accompanying drawings.

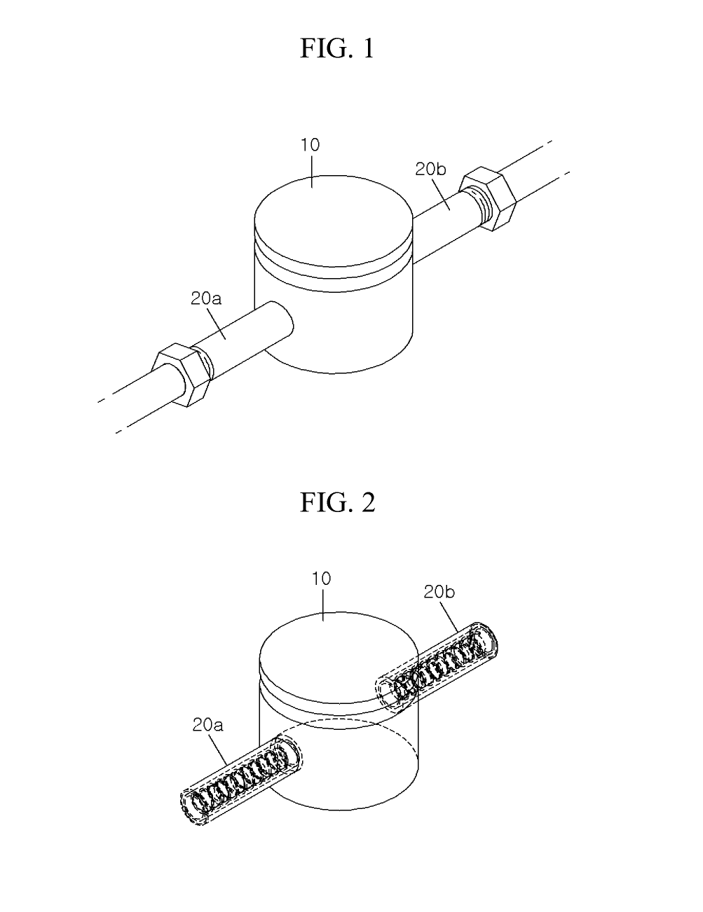

FIG. 1 is a perspective view showing a configuration in which water pipes are connected to a typical type of water meter. It can be appreciated that the water pipes 20a and 20b, which are typically referred to as union pipes, are connected to both sections of the water meter 10. Then, other water pipes (not shown) are respectively connected to the water pipes 20a and 20b and extend in the longitudinal direction, such that tap water can be introduced into a building in which the water meter is installed.

According to an aspect of the present invention, a device for magnetizing (ionizing) water is disposed along a predetermined length of the water pipes which are connected to both sections of the water meter. Therefore, the device has a simplified structure, since additional components for ionization of water can be omitted unlike the related art. Since the device can be maintained by the separation operation of the water pipe connected to the water meter or the replacement operation of the water meter, workability is improved and maintenance cost is reduced.

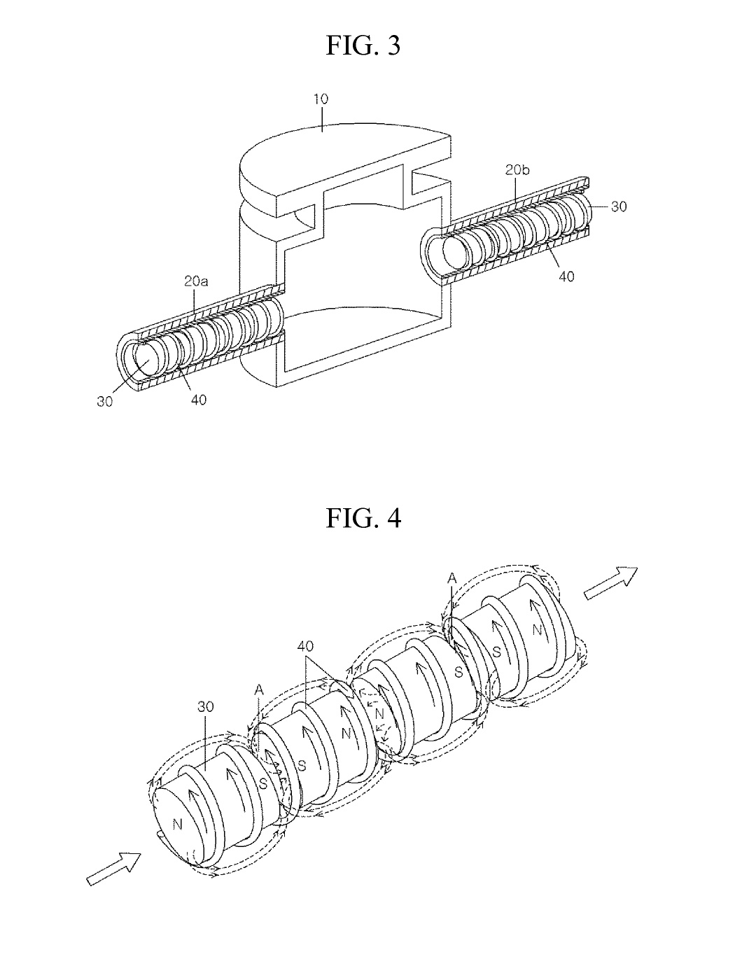

FIG. 2 is a perspective view showing a configuration in which a water treatment apparatus is implemented inside a water pipe connected to a water meter according to an embodiment of the present invention. Referring to FIG. 2, components for water treatment are housed inside the water pipes 20a and 20b connected to both sections of the water meter 10. FIG. 3 is a partially cutaway perspective view of FIG. 2 showing the cross-sectional shapes of the water meter 10 and the water pipe 20a and 20b together with the shapes of magnets 30 and coil springs 40 disposed inside the water pipes 20a and 20b. This figure depicts that water can be magnetized (ionized) under the influence of the magnets 30 and the coil springs 40 when passing through the water meter 10. Although the magnets 30 and the coil springs 40 shown in FIG. 3 are disposed inside both of the water pipes 20a and 20b connected to the water meter 10, this is not intended to limit the present invention. Rather, the water treatment apparatus including the magnets 30 and the coil springs 40 can be disposed in only one water pipe. It is to be understood that the water treatment apparatus can be selectively embodied in one or both sections depending on the intensity of magnets or the quality or quantity of tap water to be treated.

Each of the coil springs 40 of an embodiment of the present invention is configured such that it can be in close and sealing contact with the inner surface of the water pipe when being disposed inside the water pipe. In addition, the magnets 30 inside the coil spring 40 can be in close and sealing contact with the spring 40. This structure defines a space between the inner surface of the water pipe, the outer surfaces of the coil spring, and the outer surfaces of the magnets. This space forms a passage G along which water can swirl and flow. In this embodiment, the water pipe has a circular cross-section of a typical shape, and the coil spring and the magnets which are inserted into the water pipe to form the sealed structure also have a circular cross-section. However, the present invention is not limited to the circular shape. The cross-sectional shape is not necessarily limited to the circular shape, but can also be equivalently applied to other structures which have other cross-sectional shapes such as a rectangular shape. It is to be translated that any structures can be equivalently applied as long as the water passage G closed by the inner surface of the water pipe, the coil spring and the magnets can be formed therein.

According to an embodiment of the present invention, a plurality of the magnets 30, particularly, two magnets are disposed, and are spaced apart from each other with intervals which can form spaces. These spaces, i.e. the intervals A between the magnets are intended to allow water to be more strongly influenced by magnetic force while flowing. Water is magnetized (ionized) by horizontal magnetic force while flowing along the water passage G under the influence of the magnetic force. When this water passes through the intervals A between the magnets, the water is magnetized (ionized) by vertical magnetic force. In this way, the water is continuously influenced by magnetic force. The magnets which are employed in an embodiment of the present invention can be, for example, a Neodium magnet having magnetic force of 3,500 gausses or greater. A plurality of these magnets, particularly, two or more magnets, can be provided in order to strengthen the magnetization (ionization) of water using at least one interval A between the magnets. In consideration of the feature of the water treatment apparatus of this embodiment which is disposed inside the water pipe, magnetic force can be directly applied to flowing water. Magnetic force is applied in various directions, such as in horizontal and vertical directions, so that the magnetization (ionization) of water can be more easily effected than in the related art.

In addition, according to an embodiment of the present invention, a plurality of the magnets, such as two or more magnets, are arranged such that the opposing magnetic poles of adjacent magnets are of the same polarity such that repulsive force can occur between the magnets. Referring to FIG. 4 to FIG. 6, four magnets 30 are disposed inside the coil spring 40. It is apparent that the magnets 30 are spaced apart from each other at regular intervals and extend for the length of the coil spring 40, and that the opposing magnetic poles are of the same polarity. Owing to the feature that the magnetic poles having the same polarity oppose each other, when flowing water reaches the intervals A between the magnets, water can be more strongly magnetized (ionized) under the influence of magnetic force which has repulsive force.

Water that passes through the water pipe of an embodiment of the present invention does not advance straight along the longitudinal direction of the water pipe, but advances while swirling along the water passage G which is defined by the inner surface of the water pipe and the outer surfaces of the magnet. In other words, while water is swirling along the water passage G, the amount of water that is exposed to and comes into contact with magnetic force that is generated by the magnets increases, and magnetization (ionization) of water can be thereby increased as much as the increase in exposure and contact. In addition, since an embodiment of the present invention employs two or more magnets which are seated inside the coil spring such that the spaces can be formed between adjacent magnets instead of using one long cylindrical magnet, swirling and advancing water can be exposed to repulsive magnetic force in the intervals A so as to be under greater influence of magnetic force than in the related art.

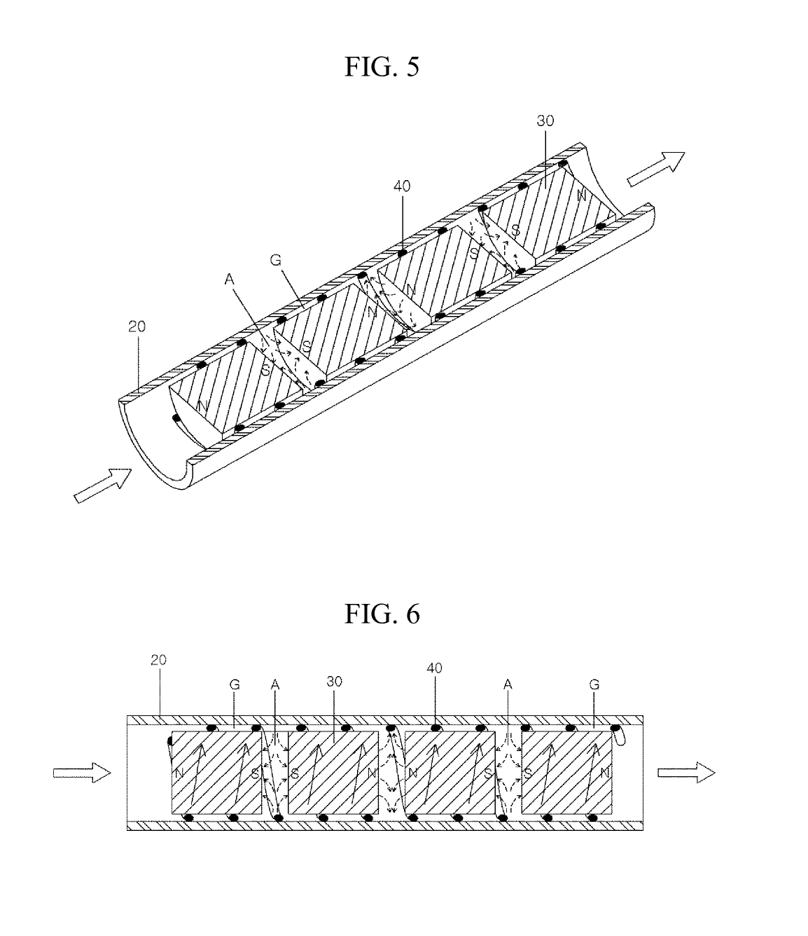

FIG. 4 shows the shape of some parts of the water meter integrated water treatment apparatus according to an embodiment of the present invention, including the plurality of magnets 30 which are spaced apart from each other and the coil spring 40 which is wound on the magnets. FIG. 5 and FIG. 6 respectively show a perspective cross-sectional view and a front cross-sectional view of the water pipe 20, the coil spring 40 and the magnets 30. As shown in FIG. 4 and FIG. 6, solid arrows indicate an example of the direction in which water that passes through the water treatment apparatus according to an embodiment of the present invention swirls along the water passage G, and arrows of dotted lines indicate the direction of magnetic forces. Swirling water is under the influence of magnetic force in the horizontal direction, i.e. the longitudinal direction of the water pipe. When water reaches the interval A between the magnets, it is under the influence of repulsive magnetic force in the vertical direction, i.e. the radial direction of the water pipe.

The coil spring 40 is made of a stainless metal which does not erode in water. Even though the space is closed by the coil spring 40, magnetic force can pass through the coil spring 40 so as to affect swirling water.

It is required to prevent the interval between the magnets from varying by fixing the coil spring 40 and the magnets 30 in the close contact state. The magnets employed in an embodiment of the present invention have relatively strong magnetic force in order to strengthen magnetization (ionization) of water. Since the opposing surfaces of the magnets have the same polarity, it is possible that magnets move under repulsive force inside the spring. In an example of the present invention, the coil spring may be integrally formed with the inner surface of the water pipe and the magnets may be fixed to the coil spring using a fixing device (not shown). However, according to the present invention, structures for fixing between the coil spring and the magnets and between the inner surface of the water pipe and the coil spring are not specific limited.

According to one or more embodiments of the present invention, it is possible to increase the amount of water that is exposed to magnetic force by causing water to swirl on the outer surfaces of the magnets along the direction in which the screw is wound. The water treatment apparatus can be integrally fabricated with the water meter, thereby reducing maintenance cost. Although the exemplary embodiments of the present invention have been described for illustrative purposes, those skilled in the art will appreciate that various modifications, additions and substitutions are possible, without departing from the scope and spirit of the present invention as disclosed in the accompanying claims.

What is claimed is:

1. A water treatment apparatus integrated with water meter, comprising:
a coil spring disposed inside at least one of water pipes which are connected to both sections of the water meter, the coil spring being in close contact with an inner diameter surface of said at least one of the water pipes; and
at least two magnets disposed inside and in close contact with an inner diameter surface of the coil spring, wherein an interval is formed between the magnets in a longitudinal direction of the water pipe, and the inner diameter surface of the water pipe, the coil spring and the magnets are in close and sealing contact with each other to form a water passage through which water flows.

2. The apparatus of claim 1, wherein the water that flows through the water pipe swirls and passes through the water passage, and passes through the interval formed between the magnets.

3. The apparatus of claim 1, wherein the at least two magnets are arranged such that magnetic poles of same polarity oppose each other to generate repulsive force.

4. The apparatus of claim 1, wherein the magnets are fixed to the coil spring such that the interval is maintained to be uniform.

5. The apparatus of claim 1, wherein the coil spring comprises a plurality of coil springs each disposed inside the water pipes.

6. A water treatment apparatus, comprising:
a water meter;
a water pipe connected to the water meter;
a plurality of magnets spaced apart from each other and positioned within the water pipe;
a coil spring positioned within the water pipe and wound on the plurality of magnets to be installed between the inner surface of the water pipe and the outer surfaces of the plurality of magnets, wherein the inner surface of the water pipe, the coil spring and the magnets are in close and sealing contact with each other to form a water passage, and water that flows through the water pipe swirls and passes through the water passage, and passes through the interval formed between the magnets.

7. The apparatus of claim 6, wherein the water pipe comprises a plurality of water pipes connected to the water meter.

8. The apparatus of claim 6, wherein the at least two magnets are arranged such that magnetic poles of same polarity oppose each other to generate repulsive force.

9. The apparatus of claim 6, wherein the magnets are fixed to the coil spring such that the interval is maintained to be uniform.
